(19) United States
(12) Patent Application Publication
(10) Pub. No.: US 2024/0402436 A1
(43) Pub. Date: Dec. 5, 2024

(54) PHOTOELECTRIC COMPOSITE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroyoshi MAESOBA, Osaka (JP); Katsuya IKUTA, Osaka (JP); Hidetoshi ISHIDA, Osaka (JP)

(21) Appl. No.: 18/696,282

(22) PCT Filed: Oct. 4, 2022
(86) PCT No.: PCT/JP2022/037081

§ 371 Date: Mar. 27, 2024

(30) Foreign Application Priority Data
Oct. 5, 2021 (JP) 2021-163995

(51) Int. Cl. G02B 6/38; H01R 12/70; H01R 13/405

(52) U.S. Cl. CPC G02B 6/3817; G02B 6/3877; G02B 6/3897; H01R 12/707; H01R 13/405

(57) ABSTRACT

A photoelectric composite connector mounted on a circuit board is provided, in which assembly of the photoelectric composite connector can be performed easily. A photoelectric composite connector 1 attached to a circuit board, comprising at least one optical ferrule 40, at least one electrical connection terminal 50, a housing 10 to which the optical ferrule 40 and the electrical connection terminal 50 can be attached, and a retainer member 20 that can be fitted in the housing 10, the electrical connection terminal 50 being directly secured to the housing 10, and the optical ferrule 40 being sandwiched between the housing 10 and the retainer member 20 and held in the housing 10.

### TECHNICAL FIELD

The present disclosure relates to a photoelectric composite connector.

### BACKGROUND

An optical cable using an optical fiber is widely used in information communication for household, industry and the like since high-speed communication of a large amount of information is possible. Further, various electronic devices such as a car navigation system are equipped in an automotive vehicle. Optical communication using an optical cable has begun to be used also for communication in those devices. Particularly, the speed up of communication has accelerated in the field of automotive vehicles in recent years. However, there are many problems in carrying out high-speed communication exceeding several Gbps by an electrical cable. With the speed up of communication, optical cables capable of dealing with high-speed communication are becoming more and more important in in-vehicle communication devices. Particularly, an optical cable provided with an optical fiber made of glass can be suitably used in high-speed communication.

On the other hand, an optical cable is not suitable for supplying an energy necessary to operate a communication device, and a wire provided with a metal wire is also used together with the optical cable. Accordingly, to enable an optical cable and a wire to be easily connected to a printed circuit board of a communication device or the like, connectors capable of collectively connecting an optical cable and a wire to a printed circuit board of a device have been and are being developed. Optical-electrical composite connectors of that type are disclosed in patent literature 1 and the like and some have been put to practical use.

### PRIOR ART DOCUMENT

### Patent Document

Patent Document 1: International Publication WO 2007/088863

### SUMMARY OF THE INVENTION

### Problems to be Solved

As described above, photoelectric composite connectors have been and are being developed as a means for collectively connecting an optical cable and a wire to a printed circuit board, but the composite connectors of that type tend to be difficult to manufacture as compared to optical connectors for connecting only an optical cable and electrical connectors for connecting only a wire. Patent literature 1 discloses a photoelectric composite connector to be mounted on a circuit board. A transmission side module including a light emitting element and a reception side module including a light receiving element are incorporated, together with an electrical connector and an optical connector, into this photoelectric composite connector. If the modules for optical communication are incorporated into the connector in this way, the internal structure of a connector housing becomes complicated and high accuracy is required for the alignment of respective members to be accommodated. Then, it is difficult to assemble the composite connector. Further, a manufacturing process and a manufacturing facility are normally totally different for optical connectors and for electrical connectors and it tends to be difficult to assemble a composite connector provided with both an electrical connection part and an optical communication part including modules in the same manufacturing line. Particularly, with the speed up of communication in automotive vehicles, conventionally used plastic optical fibers (POFs) have been replaced by glass optical fibers (AGFs) in recent years. Since AGFs have a smaller diameter than POFs, an optical communication member for AGF is smaller in size than an optical communication member for POF and required to have a high arrangement accuracy. Thus, it is particularly difficult to manufacture a composite connector by precisely arranging the optical communication member for AGF in a connector housing.

Accordingly, it is aimed to provide an easily assemblable photoelectric composite connector to be mounted on a circuit board.

### Means to Solve the Problem

The present disclosure is directed to a photoelectric composite connector to be mounted on a circuit board, the photoelectric composite connector being provided with at least one optical ferrule, at least one electrical connection terminal, a housing mountable with the optical ferrule and the electrical connection terminal, and a retainer member fittable to the housing, the electrical connection terminal being directly fixed to the housing, and the optical ferrule being held in the housing by being sandwiched between the housing and the retainer member.

### Effect of the Invention

A photoelectric composite connector according to the present disclosure is an easily assemblable photoelectric composite connector to be mounted on a circuit board.

### BRIEF DESCRIPTION OF THE DRAWINGS

FIG. 1 is a perspective view of a photoelectric composite connector according to one embodiment of the present disclosure when viewed from behind.

FIG. 2 is a perspective view of the photoelectric composite connector when viewed from front.

FIG. 3 is a perspective view showing a state where a retainer member is removed in FIG. 1.

FIGS. 4A and 4B are sections of the photoelectric composite connector, wherein FIG. 4A enlargedly shows a transverse cross-section at the position of a terminal mounting portion and FIG. 4B shows a transverse cross-section at the position of a ferrule mounting portion.

FIG. 5 is a diagram showing a used state of the photoelectric composite connector together with related members.

### DETAILED DESCRIPTION TO EXECUTE THE INVENTION

### Description of Embodiments of Present Disclosure

First, embodiments of the present disclosure are listed and described.

The photoelectric composite connector of the present disclosure is to be mounted on a circuit board and provided with at least one optical ferrule, at least one electrical connection terminal, a housing mountable with the optical ferrule and the electrical connection terminal, and a retainer member fittable to the housing, the electrical connection terminal being directly fixed to the housing, and the optical ferrule being held in the housing by being sandwiched between the housing and the retainer member.

The photoelectric composite connector is provided with the optical ferrule as an optical communication member. An optical fiber can be coupled to this optical ferrule and coupled to an optical communication module including a light emitting element, a light receiving element and the like. Then, even without incorporating an optical communication module into the photoelectric composite connector, an optical signal can be transmitted and received between an optical communication member such as an optical ferrule of a mating connector and the optical communication module. By not incorporating the optical communication module into the photoelectric composite connector, the structure of the photoelectric composite connector is simplified and the photoelectric composite connector is easily assembled. Further, in the above photoelectric composite connector, the optical ferrule is not directly fixed to the housing, but is held in the housing by being sandwiched between the housing and the retainer member fit to the housing. Thus, only by fitting the retainer member to the housing, the optical ferrule can be mounted in the housing and the photoelectric composite connector is more easily assembled. An effect of simplifying an assembly process of the photoelectric composite connector is particularly notable in the case of applying the photoelectric composite connector to optical communication using a thin optical fiber such as an AGF.

Here, the photoelectric composite connector may be further provided with a split sleeve, the optical ferrule being insertable into the split sleeve, and the optical ferrule may be held in the housing by being sandwiched between the housing and the retainer member with a tip portion of the optical ferrule accommodated in the split sleeve. By using the split sleeve, the optical ferrule can be positioned with high accuracy in the photoelectric composite connector. Further, optical communication can be performed with the tip surfaces of the both optical ferrules accurately butted against each other by inserting the optical ferrule of the mating connector into the split sleeve from an opposite side.

The optical ferrule may be coupled to an optical fiber and fixed to the circuit board via the optical fiber or coupled to an optical communication module mounted on the circuit board via the optical fiber. By mounting the photoelectric composite connector on the circuit board in that way, an optical signal can be transmitted and received between an external optical communication member and an optical communication member on the circuit board via the photoelectric composite connector even without providing the optical communication module in the photoelectric composite connector. Further, the same photoelectric composite connector can be used for various applications of optical communication by selecting a fixed position of the optical fiber and the type of the optical communication module coupled to the optical fiber.

The electrical connection terminal may be directly electrically connected to the circuit board at a board connecting portion projecting outwardly of the housing. Then, the configuration of an electrical connection part of the photoelectric composite connector and the configuration of a connected part to the circuit board can be simplified.

In this case, the board connecting portion of the electrical connection terminal may be electrically connected to the circuit board by surface mounting by soldering or being inserted into a through hole. Then, the configuration of the electrical connection part of the photoelectric composite connector can be simplified and electrical connection to the circuit board can be easily established.

### Details of Embodiment of Present Disclosure

Hereinafter, a photoelectric composite connector according to an embodiment of the present disclosure is described in detail using the drawings. In this specification, terms indicating the shapes and arrangements of members such as a “hollow cylindrical shape,” a “rectangular tube shape” and “parallel” include not only geometrically strict concepts, but also errors within a generally allowable range as the photoelectric composite connector.

### <Summary of Structure of Optical-Electrical Composite Connector>

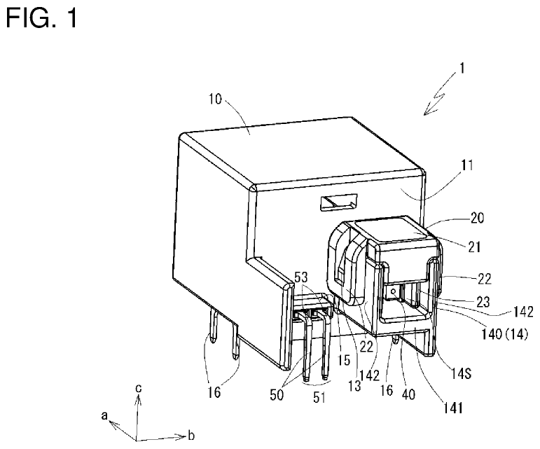

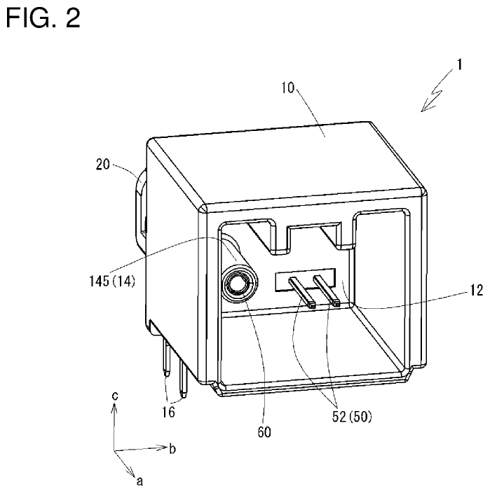

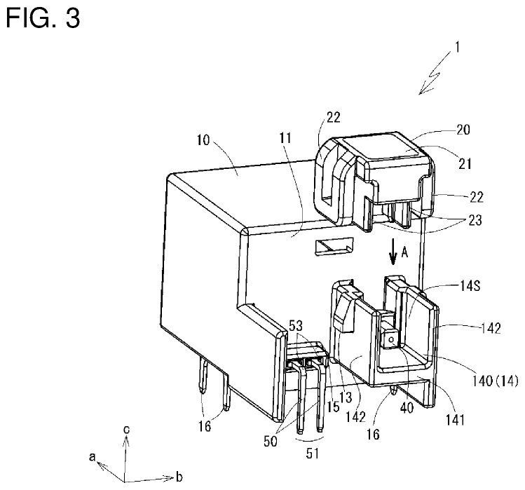

FIGS. 1 and 2 are perspective views respectively showing a photoelectric composite connector (hereinafter, may be merely referred to as a composite connector) 1 according to one embodiment of the present disclosure when viewed from behind and front. FIG. 3 shows a state where a retainer member 20 is removed in FIG. 1. The composite connector 1 according to this embodiment is configured as a board connector to be mounted on a circuit board such as a printed circuit board (PCB), and optical connection for optical communication and electrical connection for conduction are simultaneously performed between the composite connector 1 and a mating connector.

The composite connector 1 according to this embodiment is provided with at least one optical ferrule 40 as an optical communication part and at least one electrical connection terminal 50 as an electrical connection part. The composite connector 1 includes a housing 10 mountable with the optical ferrule 40 and the electrical connection terminals 50, and a retainer member 20 fittable to the housing 10. The electrical connection terminals 50 are fixed to the housing 10, and the optical ferrule 40 is mounted in the housing 10 by the retainer member 20.

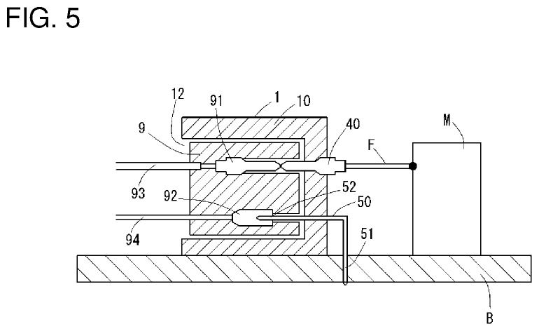

Here, before the structure of the composite connector 1 according to this embodiment is described in detail, a used state of the composite connector 1 is described. FIG. 5 shows an example of the used state of the composite connector 1, together with related members. As shown in FIG. 5, the housing 10 of the composite connector 1 is mounted on a circuit board B. The optical ferrule 40 and the electrical connection terminals 50 are mounted in the housing 10. Out of these, the electrical connection terminals 50 are directly electrically connected to the circuit board B at board connecting portions 51 on rear end sides. The optical ferrule 40 is used by being coupled to an optical fiber F. The optical fiber F is joined to the optical ferrule 40 on a tip side, and coupled to an optical communication module M mounted on the circuit board B on a rear end side. Here, the optical communication module M is a module contributing to optical communication by receiving or transmitting an optical signal, and a photodiode (PD) or a laser diode (LD) can be illustrated as such.

The housing 10 of the composite connector 1 includes a fitting portion 12 open forward. A mating connector 9 can be inserted and fit into this fitting portion 12. Here, the mating connector 9 is, for example, a photoelectric composite cable connector and provided with a mating optical ferrule 91 and mating electrical connection terminals 92. If the mating connector 9 is connected to the composite connector (board connector) 1 according to this embodiment fixed to the circuit board B, the tip surfaces of the both optical ferrules 40, 91 are butted against each other to establish optical connection. Further, terminal connecting portions 52 of the electrical connection terminals 50 and mating electrical connection terminals 92 are fit to each other to establish electrical connection. In this way, an optical signal path is formed between an optical cable 93 and the optical communication module M on the circuit board B and conduction is established between wires 94 and an electrical circuit on the circuit board B via the composite connector 1.

Although the optical fiber F coupled to the optical ferrule 40 of the composite connector 1 is directly coupled to the optical communication module M in the shown embodiment, the optical fiber F may be fixed to the circuit board B by bonding or the like. Then, the optical fiber F fixed to the circuit board B may be appropriately used for connection to another member on the circuit board B or by being pulled out to the outside of the circuit board B. For example, an intermediate part of the optical fiber F may be fixed to the circuit board B, one end thereof may be coupled to the optical ferrule 40 of the composite connector 1 and the other end thereof may be coupled to the optical communication module M mounted on the circuit board B.

### <Structure of Photoelectric Composite Connector>

Next, the structure of the photoelectric composite connector according to this embodiment is described in detail.

In this specification, a vertical direction (c direction) is specified such that a connection direction of the composite connector 1 to the circuit board B is a downward direction. Axial directions of the optical ferrule 40 and the electrical connection terminals 50 orthogonal to the vertical direction are specified as a front-rear direction (a direction). Tip sides of the optical ferrule 40 and the terminal connecting portions 52 of the electrical connection terminals 50 are front sides. Further, a direction orthogonal to the vertical direction and front-rear direction is specified as a width direction (b direction). The optical ferrule 40 and the electrical connection terminals 50 are arranged in parallel in the width direction.

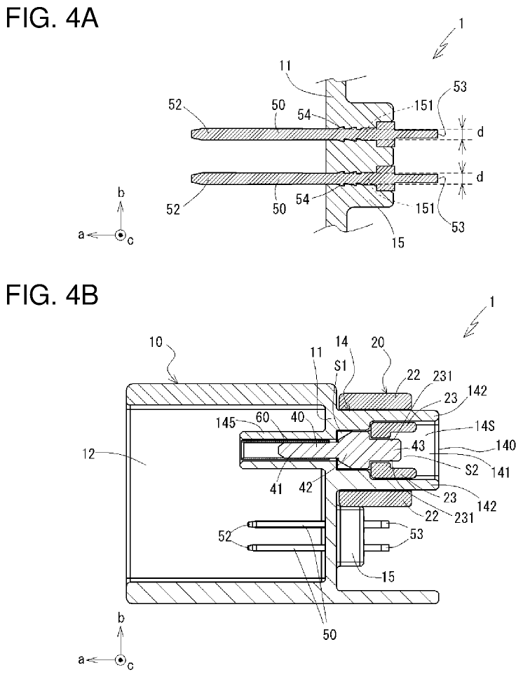

The optical ferrule 40 is constituted by a known optical fiber ferrule. The optical ferrule 40 integrally includes a tip portion 41, a flange portion 42 and a rear end portion 43 (see FIG. 4B). The tip portion 41 and the rear end portion 43 are in the form of bars. The flange portion 42 has a larger dimension than the tip portion 41 and the rear end portion 43 and has a tapered shape widened from the side of the front end portion 41 toward the side of the rear end portion 43. The optical fiber F can be coupled to the optical ferrule 40. Here, the details of the types of the optical fiber F and the optical ferrule 40 are not particularly limited. However, from the perspective of application to high-speed communication, a glass optical fiber (AGF) is preferably used as the optical fiber F. Generally widely used AGFs have a cladding diameter of 125 μm and, even in the case of a multi-mode type, have a small core diameter of 100 μm or less, and the compatible optical ferrule 40 also has a small tip surface area. The tip of the optical fiber F is coupled and fixed to the optical ferrule 40 while being held flush with the tip surface of the optical ferrule 40.

The electrical connection terminal 50 is configured as an electrical connection terminal for known insulated wire. Although the type and shape of the electrical connection terminal 50 are not particularly limited, the electrical connection terminal 50 includes the terminal connecting portion 52 on a front end side and the board connecting portion 51 on a rear end side here. The terminal connecting portion 52 is a connecting portion electrically connectable to the electrical connection terminal 92 of the mating connector 9 and, for example, the form of a fitting-type male terminal can be suitably applied. The board connecting portion 51 is a connecting portion electrically connectable to the circuit board B. In the shown embodiment, the board connecting portion 51 is configured as a through hole pin to be inserted into a through hole of the circuit board B. Alternatively, the board connecting portion 51 may be configured as a board connection terminal (SMT terminal) to be surface-mounted by soldering, a press-fit pin to be press-fit into the through hole or the like. In the shown embodiment, the electrical connection terminal 50 includes a bent portion 53 in an intermediate part, whereby the terminal connecting portion 52 extends forward and the board connecting portion 51 extends downward. Projections 54 protruding in the width direction in a stepwise manner (see FIG. 4A) are provided on a part between the terminal connecting portion 52 and the bent portion 53.

In the shown embodiment, the composite connector 1 is provided with one optical ferrule 40 and a pair of the electrical connection terminals 50. However, the numbers of the optical ferrules 40 and the electrical connection terminals 50 provided in the composite connector 1 are not particularly limited as long at least one of each is provided. In the case of providing a plurality of the optical ferrules 40, each optical ferrule 40 is independently coupled to the optical fiber F.

The housing 10 is a case member made of resin. The housing 10 is substantially in the form of a rectangular tube including the fitting portion 12 as a space capable of accommodating the mating connector 9 on a front side. At positions of a rear wall surface 11, the housing 10 includes a ferrule mounting portion 14 for mounting the optical ferrule 40 and a terminal mounting portion 15 for mounting the electrical connection terminals 50, integrally with the rear wall surface 11.

The electrical connection terminals 50 are directly fixed to the housing 10 in the terminal mounting portion 15. FIG. 4A enlargedly shows a transverse cross-section at the position of the terminal mounting portion 15, i.e. a cross-section passing through centers of the electrical connection terminals 50 and perpendicular to the vertical direction. The terminal mounting portion 15 is provided with terminal insertion holes 151 as holes penetrating through the rear wall surface 11 of the housing 10. The electrical connection terminals 50 are inserted through the terminal insertion holes 151 and held in the terminal mounting portion 15 at the positions of the projections 54. A width d of the terminal insertion hole 151 of the terminal mounting portion 15 is smaller than a width of the electrical connection terminal 50, and the electrical connection terminal 50 is fixed to the terminal mounting portion 15 by being press-fit into the terminal insertion hole 151. Further, tops of the projections 54 bite into the wall surface of the terminal insertion hole 151, whereby the electrical connection terminal 50 is firmly fixed. If the electrical connection terminal 50 is fixed in the terminal mounting portion 15, the terminal connecting portion 52 projects forward in the fitting portion 12 of the housing 10 in a front part of the electrical connection terminal 50. On the other hand, a rear part of the electrical connection terminal 50 projects rearward outside the rear wall surface 11 of the housing 10 and the board connecting portion 51 projects downward across the bent portion 53.

The optical ferrule 40 is held in the housing 10 in the ferrule mounting portion 14, but not directly fixed to the housing 10 unlike the electrical connection terminals 50. FIG. 4B shows a transverse cross-section of the composite connector 1 at the position of the ferrule mounting portion 14, i.e. a cross-section passing through a center of the optical ferrule 40 and perpendicular to the vertical direction. The ferrule mounting portion 14 integrally includes a tubular portion 145 provided in front of the rear wall surface 11 of the housing 10 and an open portion 140 provided behind the housing rear wall surface 11. The tubular portion 145 is a hollow cylindrical part extending forward into the fitting portion 12 from the rear wall surface 11 of the housing 10 and is open on both front and rear ends. An inner diameter of the tubular portion 145 is set such that a split sleeve 60 to be described later can be press-fit and the flange portion 42 of the optical ferrule 40 cannot be inserted.

The open portion 140 of the ferrule mounting portion 14 integrally has a bottom surface 141 extending rearward from the housing rear wall surface 11 and side surfaces 142 rising on both widthwise ends of the bottom surface 141. An accommodation space 14S surrounded by the bottom surface 141 and the side surfaces 142 on both sides is continuous with a hollow part of the tubular portion 145. Upper and rear sides of the accommodation space 14S are open without being covered by wall surfaces. The accommodation space 14S can accommodate the flange portion 42 and the rear end portion 43 of the optical ferrule 40. Step structures are formed along the front-rear direction inside the side surfaces 142 such that a front part of the accommodation space 14S serves as a flange portion accommodation space S1 having a narrow width and a rear part of the accommodation space 14S serves as a rear end portion accommodation space S2 having a wide width. Engaging projections 13 are formed outside the side surfaces 142 on the both sides of the open portion 140.

The optical ferrule 40 is accommodated into the tubular portion 145 of the ferrule mounting portion 14 with the tip portion 41 accommodated in the split sleeve 60. The split sleeve 60 is a tubular member made of metal and formed with a slit along an axial direction, and squeezes and holds the optical ferrule 40 inserted thereinto inwardly with a resilient force. The split sleeve 60 functions to make the positioning of the optical ferrule 40 easier and more accurate and further enhance the accuracy of connection to the optical ferrule 91 of the mating connector 90.

In the ferrule mounting portion 14, the split sleeve 60 having the tip portion 41 of the optical ferrule 40 inserted therein is inserted into the tubular portion 145 from behind. In a state after insertion, the split sleeve 60 is press-fit in the tubular portion 145 and the tip portion 41 of the optical ferrule 40 is press-fit in a rear part of the split sleeve 60. The flange portion 42 and the rear end portion 43 of the optical ferrule 40 are accommodated into the accommodation space 14S of the open portion 140 and project rearwardly of the housing rear wall surface 11. The flange portion 42 of the optical ferrule 40 is accommodated into the flange portion accommodation space S1, and the rear end portion 43 is accommodated into the rear end portion accommodation space S2. Note that a space, into which the optical ferrule 91 of the mating connector 9 can enter, is left in front of the split sleeve 60.

The retainer member 20 can be fit to the ferrule mounting portion 14 of the housing 10 having the optical ferrule 40 mounted in this way. The retainer member 20 includes a ceiling portion 21 and a pair of engaging portions 22 and a pair of inserting portions 23 as plate-like members respectively hanging down from the ceiling portion 21. The engaging portions 22 are provided on both widthwise ends of the retainer member 20, and the inserting portions 23 are provided inwardly of the engaging portions 22 in the width direction.

If the retainer member 20 is arranged above the ferrule mounting portion 14 of the housing 10 and mounted from above to cover the open portion 140 of the ferrule mounting portion 14 from above by the ceiling portion 21 of the retainer member 20 (arrow A of FIG. 3), the engaging portions 22 of the retainer member 20 are arranged outside the side surfaces 142 of the ferrule mounting portion 14 while being resiliently deformed to be pushed and expanded outward in the width direction. The engaging portions 22 of the retainer member 20 are provided with holes penetrating in a plate thickness direction, and the engaging projections 13 provided on the side surfaces 142 of the ferrule mounting portion 14 are fit into and engaged with these holes, whereby the retainer member 20 is fixed to the ferrule mounting portion 14.

With the retainer member 20 mounted on the ferrule mounting portion 14 in this way, the inserting portions 23 of the retainer member 20 are inserted in the accommodation space 14S of the open portion 140 of the ferrule mounting portion 140. More particularly, the inserting portions 23 of the retainer member 20 are inserted in the rear end portion accommodation space S2 on the rear side, out of the accommodation space 14S. The rear end portion 43 of the optical ferrule 40 is already accommodated in the rear end portion accommodation space S2, and the inserting portions 23 of the retainer member 20 are press-fit into gaps formed between the rear end portion 43 of the optical ferrule 40 and the side surfaces 142 of the ferrule mounting portion 14. Pressing portions 231 serving as parts projecting inward in the width direction are integrally provided on tip sides of the inserting portions 23 of the retainer member 20, and these pressing portions 231 contact the rear end portion 43 of the optical ferrule 40. By press-fitting the inserting portions 23 into the narrow gaps, the inserting portions 23 are resiliently deformed and inward forces in the width direction act between the pressing portions 231 of the pair of inserting portions 23. By these forces, the optical ferrule 40 is held at the rear end portion 43. Further, the optical ferrule 40 is prevented from coming out rearward by the contact of front end parts of the inserting portions 23 of the retainer member 20 with the rear end surface of the flange portion 42 of the optical ferrule 40.

In this way, the optical ferrule 40 is accommodated into the ferrule mounting portion 14 of the housing 10 and the retainer member 20 is fit to the ferrule mounting portion 14, whereby the optical ferrule 40 is sandwiched between the housing 10 and the retainer member 20. By this sandwiching, the optical ferrule 40 is held at a predetermined position of the housing 10. By using the retainer member 20 in this way, the optical ferrule 40 can be mounted and held in the housing 10 even without being directly fixed to the housing 10.

Further, the housing 10 is provided with a plurality of pins 16 for physically fixing the composite connector 1 to the circuit board B. The pins 16 are respectively insertable into through holes of the circuit board B. By inserting the pins 16 into the through holes of the circuit board B and appropriately fixing the pins 16 by soldering or the like, the composite connector 1 can be fixed to the circuit board B.

The photoelectric composite connector 1 according to this embodiment is easily assembled by having the configuration described above. As described with reference to FIG. 5, the optical ferrule 40 is provided as an optical communication member in the composite connector 1 and the optical ferrule 40 can be fixed to the circuit board B and coupled to the optical communication module M mounted on the circuit board B via the optical fiber F by coupling the optical fiber F to the optical ferrule 40. Thus, even without incorporating an optical communication module into the composite connector 1, optical communication between the mating connector 9 and the optical communication module M fixed to the circuit board B can be performed via the composite connector 1. Since it is not necessary to incorporate the optical communication module into the composite connector 1, the structure of the composite connector 1 is simplified and the optical communication module needs not be precisely arranged inside the connector. Thus, an assembling operation of the composite connector 1 is easily performed. Particularly, if the optical communication module is incorporated into the connector used to relay communication using an AGF, small-size optical communication members need to be incorporated into the connector and those optical communication members are required to be arranged with high accuracy since the AGF is thin in diameter. However, by applying the configuration of the composite connector 1 according to this embodiment, a high effect is obtained in improving assemblability. Note that it is not prevented to incorporate the optical communication module inside the composite connector 1 according to this embodiment, but it is preferable not to incorporate the optical communication module in terms of simplifying the structure and assembly process of the composite connector 1.

Further, in the composite connector 1 according to this embodiment, the optical ferrule 40 is held in the housing by being sandwiched between the housing 10 and the separate retainer member 20 without being fixed to the housing 10. Since the optical ferrule 40 can be mounted only by fitting the retainer member 20 to the ferrule mounting portion 14 having the ferrule 40 at the predetermined position in the housing 10, the convenience of an operation of incorporating the optical ferrule 40 into the composite connector 1 is enhanced. Also in the case of mounting the small-size optical ferrule 40 such as an optical ferrule for AGF, the convenience of the mounting operation remains substantially unchanged.

In this composite connector 1, the optical ferrule 40 is held in the housing 10 using the retainer member 20 and fixed to the circuit board B or coupled to the optical communication module M via the optical fiber F, but the electrical connection terminals 50 are directly fixed to the housing 10 and also directly electrically connected to the circuit board B. The configuration of the entire composite connector 1 can be simplified by simplifying a mounting mechanism into the housing 10 and a connecting mechanism to the circuit board B for the electrical connection terminals 50.

### OTHER EMBODIMENTS

As described above, the type and number of the electrical connection terminals 50 are not particularly limited. For example, either ordinary terminals not supposed to comply with specific standards or terminals satisfying predetermined standards such as Ethernet (registered trademark) standards may be used as the electrical connection terminals 50. The use of ordinary terminals is better due to low cost and the use of terminals satisfying predetermined standards is better in being able to ensure performances of electrical connecting portions such as communication performance.

In the case of providing a plurality of the electrical connection terminals 50, an arrangement direction of those electrical connection terminals 50 is also not particularly limited. In the above embodiment, the pair of electrical connection terminals 50 are arranged in the width direction (b direction) together with the optical ferrule 40 (hereinafter, referred to as “series arrangement”) as shown. However, for example, the pair of electrical connection terminals 50 arranged in the vertical direction (c direction) and the optical ferrule 40 may be arranged in the width direction (b direction) (hereinafter, referred to as “parallel arrangement”). Which of the series arrangement and the parallel arrangement should be adopted may be selected according to the use application of the composite connector 1, the type of the electrical connection terminals 50 and the like. The parallel arrangement is excellent in space saving since the entire composite connector 1 is easily set to have a small size. On the other hand, the series arrangement is preferable in terms of ensuring communication performance. This is because, if the series arrangement as shown is adopted, the pair of electrical connection terminals 50 are laterally arranged along the surface of the circuit board B and electrical connection paths from the electrical connection terminals 92 of the mating connector 9 to the circuit board B, i.e. distances from the tips of the terminal connecting portions 52 of the electrical connection terminals 50 to the tips of the board connecting portions 51, are easily made equal between the pair of electrical connection terminals 50. In the case of the parallel arrangement, the pair of electrical connection terminals 50 are vertically arranged with respect to the circuit board B and lengths of a pair of electrical connection paths tend to be different. Particularly, in the case of using terminals satisfying communication standards such as Ethernet standards as the electrical connection terminals 50, the series arrangement may be adopted in terms of ensuring communication performance.

The present invention is not limited at all by the above embodiment and various modifications can be made without departing from the gist of the present invention.

### LIST OF REFERENCE NUMERALS

1 (photoelectric) composite connector
10 housing
11 housing rear wall surface
12 fitting portion
13 engaging projection
14 ferrule mounting portion
140 open portion
141 bottom surface
142 side surface
145 tubular portion
14S accommodation space
15 terminal mounting portion
151 terminal insertion hole
16 pin
20 retainer member
21 ceiling portion
22 engaging portion
23 inserting portion
231 pressing portion
40 optical ferrule
41 tip portion
42 flange portion
43 rear end portion
50 electrical connection terminal
51 board connecting portion
52 terminal connecting portion
53 bent portion
54 projection
60 split sleeve
9 mating connector
91 optical ferrule
92 electrical connection terminal
93 optical cable
94 wire
a front-rear direction
b width direction
c height direction
d width of terminal insertion hole
A retainer member mounting direction
B circuit board
F optical fiber
M optical communication module
S1 flange portion accommodation space
S2 rear end portion accommodation space

1. A photoelectric composite connector to be mounted on a circuit board, comprising:
at least one optical ferrule;
at least one electrical connection terminal;
a housing mountable with the optical ferrule and the electrical connection terminal; and
a retainer member fittable to the housing,
the electrical connection terminal being directly fixed to the housing, and
the optical ferrule being held in the housing by being sandwiched between the housing and the retainer member.

2. The photoelectric composite connector according to claim 1, further comprising a split sleeve, the optical ferrule being insertable into the split sleeve, wherein:
the optical ferrule is held in the housing by being sandwiched between the housing and the retainer member with a tip portion of the optical ferrule accommodated in the split sleeve.

3. The photoelectric composite connector according to claim 1, wherein the optical ferrule is coupled to an optical fiber and fixed to the circuit board via the optical fiber or coupled to an optical communication module mounted on the circuit board via the optical fiber.

4. The photoelectric composite connector according to claim 1, wherein the electrical connection terminal is directly electrically connected to the circuit board at a board connecting portion projecting outwardly of the housing.

5. The photoelectric composite connector according to claim 4, wherein the board connecting portion of the electrical connection terminal is electrically connected to the circuit board by surface mounting by soldering or being inserted into a through hole.
